(19) United States
(12) Patent Application Publication
(10) Pub. No.: US 2024/0340652 A1
(43) Pub. Date: Oct. 10, 2024

(54) INFORMATION PROCESSING APPARATUS, INSTALLATION ARRANGEMENT CALCULATION METHOD AND PROGRAM

(71) Applicant: NIPPON TELEGRAPH AND TELEPHONE CORPORATION, Tokyo (JP)

(72) Inventors: Akio KAWABATA, Tokyo (JP); Takuya TOJO, Tokyo (JP)

(73) Assignee: NIPPON TELEGRAPH AND TELEPHONE CORPORATION, Tokyo (JP)

(21) Appl. No.: 18/579,053

(22) PCT Filed: Jul. 16, 2021
(86) PCT No.: PCT/JP2021/026834

§ 371 Date: Jan. 12, 2024

(51) Int. Cl. H04W 16/18; H04W 24/10

(52) U.S. Cl. CPC H04W 16/18; H04W 24/10

(57) ABSTRACT

An information processing device includes: a network information acquisition unit that acquires network information indicating a delay time of data transmission in a network including a data measurement device and a plurality of server devices; and a deployment configuration calculation unit that calculates a deployment configuration of functions of an application and a database for processing data transmitted from the data measurement device to each of the plurality of server devices on the basis of the network information.

### TECHNICAL FIELD

The present invention relates to an information processing device, a deployment configuration calculation method, and a program.

### BACKGROUND ART

With the spread of cloud services, a model has been achieved in which a cloud or a server on a network performs processing necessary for data analysis, and an IoT device transfers data necessary for analysis via the network. In such a processing model, in an application (for example, face recognition) with a strict delay requirement, it is necessary to shorten a time for transferring data from an IoT device such as a camera to a cloud or a server that processes data, and it is necessary to devise to deploy an application that processes data near the IoT device.

For example, Non Patent Literatures 1 to 3 disclose methods of offloading a request necessary for data processing to a cloud, a plurality of servers, or the like in order to minimize the time required for data processing.

### CITATION LIST

### Non Patent Literature

Non Patent Literature 1: Z. Fei, Y. Wang, R. Sun, and Y. Liu, “Delay-oriented task scheduling and bandwidth allocation in fog computing networks,” 2019 IEEE Global Communications Conference (GLOBECOM), pp. 1-6, 2019.
Non Patent Literature 2: A. Yousefpour, G. Ishigaki, and J. P. Jue, “Fog computing: Towards minimizing delay in the internet of things,” 2017 IEEE international conference on edge computing (EDGE), pp. 17-24, 2017.
Non Patent Literature 3: W. Masri, R. Al Ridhawi, N. Mostafa, and P. Pourghomi, “Minimizing delay in IoT systems through collaborative fog-to-fog (F2F) communication,” 2017 Ninth International Conference on Ubiquitous and Future Networks (ICUFN), pp. 1005-1010, 2017.

### SUMMARY OF INVENTION

### Technical Problem

Although these conventional technologies propose a method for optimizing offload to a cloud, a server, or the like, but the technologies only deal with the manner to distribute requests. However, in an application (APL) such as face recognition, it is necessary to acquire data used for collation of face recognition from a database (DB) of a cloud or a central server in addition to image data transmitted from an IoT device such as a camera. Therefore, in order to minimize the delay in data processing, it is necessary to properly arrange the application and the database to minimize both the processing delay between the IoT device and the APL and the processing delay between the APL and the DB.

An object of the disclosed technology is to optimize arrangement of an application and a database.

### Solution to Problem

The disclosed technology is an information processing device including: a network information acquisition unit that acquires network information indicating a delay time of data transmission in a network including a data measurement device and a plurality of server devices; and a deployment configuration calculation unit that calculates a deployment configuration of functions of an application and a database for processing data transmitted from the data measurement device to each of the plurality of server devices on the basis of the network information.

### Advantageous Effects of Invention

It is possible to optimize arrangement of an application and a database.

### BRIEF DESCRIPTION OF DRAWINGS

FIG. 1 is a diagram illustrating a system configuration example of a data processing system.

FIG. 2 is a diagram illustrating a functional configuration example of an information processing device.

FIG. 3 is a flowchart illustrating an example of a flow of server control processing.

FIG. 4 is a diagram illustrating a hardware configuration example of a computer.

### DESCRIPTION OF EMBODIMENTS

The following is a description of an embodiment (the present embodiment) of the present invention, with reference to the drawings. The embodiment described below is merely an example, and embodiments to which the present invention is applied are not limited to the embodiment described below.

### OUTLINE OF PRESENT EMBODIMENT

A data processing system according to the present embodiment includes an information processing device and a plurality of server devices. The information processing device calculates a deployment configuration of an application and a database for a plurality of server devices for processing data acquired from an IoT device, and controls each server device on the basis of a calculation result.

### (System Configuration Example of Data Processing System)

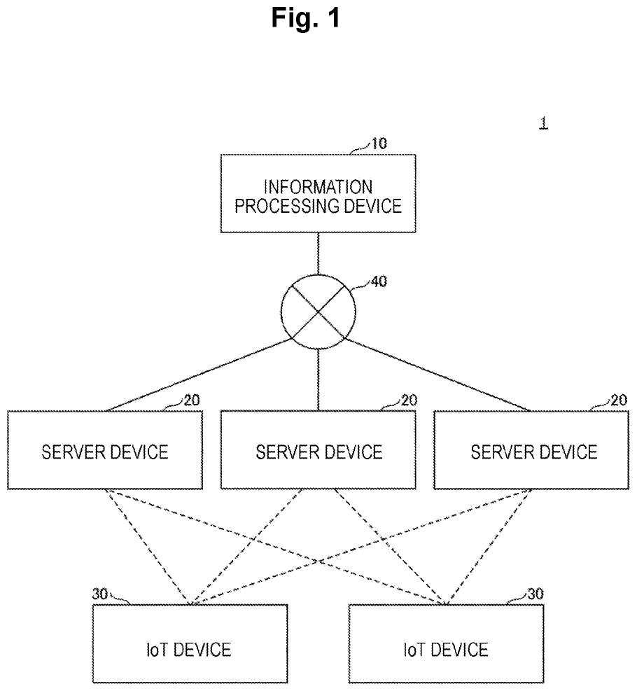

FIG. 1 is a diagram illustrating a system configuration example of a data processing system. A data processing system 1 includes an information processing device 10 and a plurality of server devices 20. The information processing device 10 and the plurality of server devices 20 are communicably connected to each other via a communication network 40.

The information processing device 10 receives, from each of the server devices 20, network information indicating a delay time in data transmission from the IoT device 30 to the plurality of server devices 20 or data transmission between the server devices 20. The information processing device 10 may receive a measurement result of the delay time from another measurement device or the like, or may store network information in advance.

The information processing device 10 calculates a deployment configuration of functions of an application and a database for processing data transmitted from the IoT device 30 to each server device 20. Then, the information processing device 10 controls each server device 20 on the basis of the calculated deployment configuration.

Each of the plurality of server devices 20 measures a delay time in data reception from the IoT device 30 and transmits information indicating a measurement result to the information processing device 10. In a case where the information processing device 10 receives a measurement result from another measurement device or the like or stores network information in advance, each server device 20 may not perform measurement and transmission.

Each of the plurality of server devices 20 achieves functions of an application and a database for processing data transmitted from the IoT device 30 under the control of the information processing device 10. The server device 20 may be achieved by a cloud service or the like.

The IoT device 30 measures various types of data and transmits the data to the server device 20. The IoT device 30 is an example of a data measurement device that measures data. One or a plurality of IoT devices 30 may be provided.

### (Functional Configuration Example of Information Processing Device)

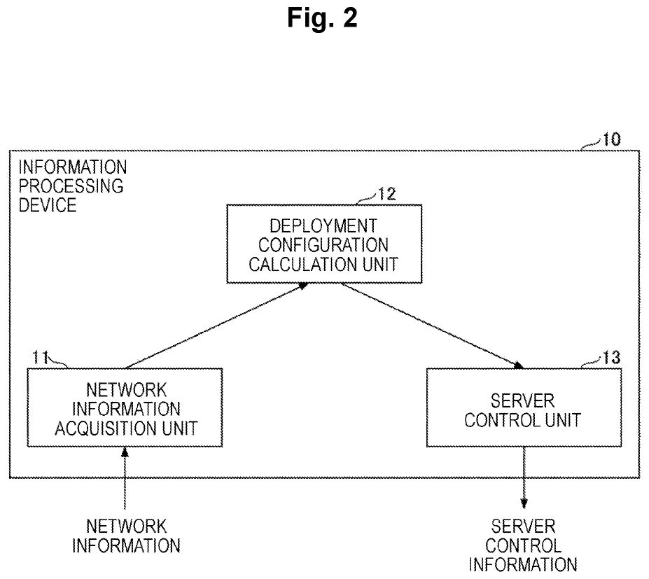

FIG. 2 is a diagram illustrating a functional configuration example of the information processing device. The information processing device 10 includes a network information acquisition unit 11, a deployment configuration calculation unit 12, and a server control unit 13.

The network information acquisition unit 11 acquires network information indicating a delay time of data transmission in a network including the IoT device 30 and a plurality of server devices 20. Specifically, the network information includes a delay time (first delay time) in data transmission from the IoT device 30 to the plurality of server devices 20 and a delay time (second delay time) in data transmission between server devices of the plurality of server devices 20.

The network information acquisition unit 11 receives network information from each server device 20, receives a measurement result from another measurement device or the like, or acquires network information stored in advance.

The deployment configuration calculation unit 12 calculates the deployment configuration of the functions of the application and the database to each server device 20 on the basis of the network information. A specific calculation method will be described later.

The server control unit 13 controls each server device 20 to achieve the functions of the application and the database on the basis of the calculated deployment configuration. Specifically, the server control unit 13 transmits server control information for controlling each server device 20 to each server device 20.

### (Operation Example of Data Processing System)

Next, an operation example of the data processing system 1 will be described with reference to the drawing. The information processing device 10 starts server control processing in response to a user operation or the like.

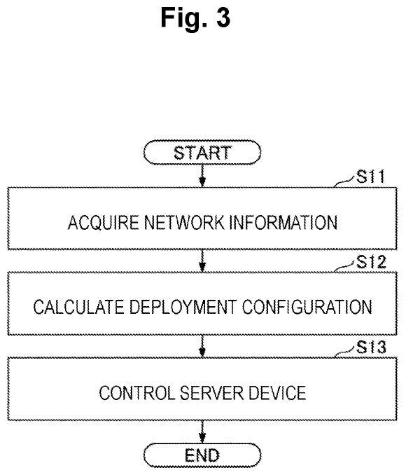

FIG. 3 is a flowchart illustrating an example of a flow of the server control processing. The network information acquisition unit 11 acquires the network information by receiving the network information from each server device 20 (step S11).

Specifically, the network information includes a network represented by an undirected graph G(V,E). Here, V represents a set of nodes, and E represents a set of links. In the following description, a set of IoT devices 30 is expressed as V_{T}⊆V, and a set of server devices 20 is expressed as V_{S}⊆V.

The node V is either the IoT device 30 or the server device 20, and there is no node having both the IoT device 30 and the server device 20. A set of links between the IoT device 30 and the server device 20 is expressed as E_{T}⊆E.

The link between the IoT device t∈V_{T} and the server device i∈V_{S} is expressed as (t, i)∈E_{T}. The link is either a link between the server device 20 and a the IoT device 30 or a link between the server devices 20, and there is no link serving as both the link between the server device 20 and the IoT device 30 and the link between the server devices 20. The delay time of the link (i, j)∈E_{S} is assumed as dᵢⱼ.
The maximum value of the IoT device 30 that can be accommodated by the server i∈V_{S} is Mᵢ.
βᵢ is a binary value, and βᵢ=1 is established when the DB can be deployed in the server i∈V_{S}, and βᵢ=0 is established when the DB cannot be deployed.
xₖₗ is a variable of a binary value, and xₖₗ=1 is established when the link (k, l)∈E is used, and xₖₗ=1 is established when it is not used.
yᵢ is a binary value, yᵢ=1 is established when the APL is deployed in the server i∈V_{S}, and yᵢ=0 is established when the APL is not deployed in the server i∈V_{S}.
zᵢ is a binary value, zᵢ=1 is established when the DB is deployed in the server i∈V_{S}, and zᵢ=0 is established when the DB is not deployed in the server i∈V_{S}.
The maximum delay of the link of the IoT device t∈V_{T} and the server i∈V_{S} operating the APL is expressed as below.

$${T}_{A}^{max} = {max}_{( t , i ) ∈ {E}_{T}} ( {d}_{ti} \cdot {x}_{ti} ) \qquad [ Math . 1 ]$$

The maximum delay of the link of the server i∈V_{S} operating the APL and the server j∈V_{S} operating the DB is expressed as below.

$${T}_{D}^{max} = {max}_{( i , j ) ∈ {E}_{S}} ( {d}_{ij} \cdot {x}_{ij} ) \qquad [ Math . 2 ]$$

The deployment configuration calculation unit 12 calculates the deployment configuration of the functions of the application and the database to each server device 20 on the basis of such network information (step S12).

The expression as below is established.

$${T}_{delay} = max \{ {T}_{A}^{max} , {T}_{D}^{max} \} \qquad [ Math . 3 ]$$

The deployment configuration calculation unit 12 calculates the deployment configuration that minimizes T_{delay}. Specific constraint conditions for the calculation are as follows.

A first constraint condition is that the expression as below is satisfied.

$${\sum }_{i ∈ {V}_{s}} {x}_{ti} = 1 , ∀ t ∈ {V}_{T} \qquad [ Math . 4 ]$$

That is, one link is selected between the IoT device 30 and the server device 20.

A second constraint condition is that the expression as below is satisfied.

$${\sum }_{i ∈ {V}_{T}} {x}_{ti} \leq {M}_{i} , {∀}_{i} ∈ {V}_{s} \qquad [ Math . 5 ]$$

That is, the total number of IoT devices 30 that have selected the server i∈V_{S} does not exceed Mᵢ.

A third constraint condition is that the expression as below is satisfied.

$${\sum }_{i ∈ {V}_{s}} {z}_{i} = 1 \qquad [ Math . 6 ]$$

That is, one DB exists in the network.

A fourth constraint condition is a condition that zᵢ≤βᵢ, ∀i∈V_{S} is satisfied. That is, the DB operates in the server i.

A fifth constraint condition is a condition that yᵢ≤xₜᵢ, ∀i∈V_{S}, (t, i)∈E_{T} is satisfied. That is, in a case where the server device 20 that receives data from the at least one IoT device 30 is selected, the server device 20 operates the APL.

A sixth constraint condition is a condition that dₜᵢxₜᵢ≤T_{A}^{MAX}, ∀(t, i)∈E_{T} is satisfied. That is, the delay of the link selected between the IoT device 30 and the APL does not exceed T_{A}^{MAX}.

A seventh constraint condition is that dᵢⱼxᵢⱼ≤T_{D}^{MAX}, ∀(i, j)∈E_{S} is satisfied. That is, the delay of the link selected between the DB and the APL does not exceed the T_{D}^{MAX}.

An eighth constraint condition is that the expressions as below are satisfied.

T_{A}^{MAX}≤T_{delay},∀(t,i)∈E_{T}

T_{D}^{MAX}≤T_{delay},∀(i,j)∈E_{S}

That is, the values of T_{A}^{MAX} and T_{D}^{MAX} do not exceed T_{delay}.

A ninth constraint condition is that the expressions as below are satisfied.

xᵢⱼ≥zⱼ+yᵢ−1,∀(i,j)∈E_{S}

xᵢⱼ≤yᵢ,∀(i,j)∈E_{S}

xᵢⱼ≤zⱼ,∀(i,j)∈E_{S}

That is, yᵢ·zⱼ=xᵢⱼ is satisfied for server i∈V_{S}, server j∈V_{S}, and link (i, j)∈E_{S}.

A tenth constraint condition is that the expressions as below are satisfied.

xₖₗ∈{0,1},∀(k,l)∈E

yᵢ∈{0,1},∀i∈V_{S}

zᵢ∈{0,1},∀i∈V_{S}

That is, xₖₗ, yᵢ, and zᵢ represent binary values.

The deployment configuration calculation unit 12 can determine an optimal DB and APL deployment configuration by solving a solution satisfying these constraint conditions as an integer programming problem.

The server control unit 13 controls the server device 20 on the basis of the calculated deployment configuration (step S13).

The network information and the constraint conditions described above are merely examples, and other network information and constraint conditions may be used.

(Hardware Configuration Example according to Present Embodiment)

The information processing device 10 can be implemented, for example, by causing a computer to execute a program describing processing content described in the present embodiment. Note that the “computer” may be a physical machine or may be a virtual machine in a cloud. In a case where a virtual machine is used, “hardware” to be described herein is virtual hardware.

The program can be stored and distributed by being recorded in a computer-readable recording medium (portable memory or the like). Further, the program can also be provided through a network such as the Internet or an electronic mail.

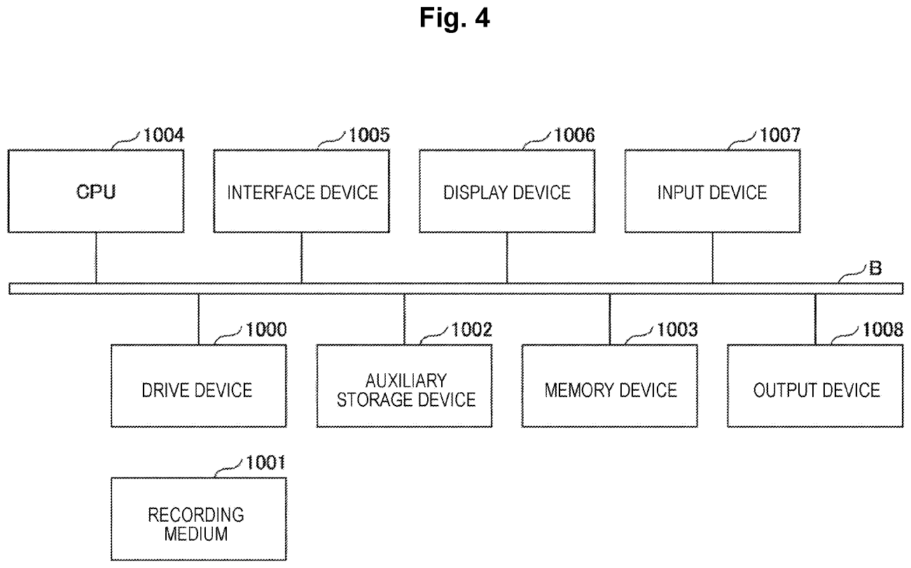

FIG. 4 is a diagram illustrating a hardware configuration example of the computer. The computer in FIG. 4 includes a drive device 1000, an auxiliary storage device 1002, a memory device 1003, a CPU 1004, an interface device 1005, a display device 1006, an input device 1007, an output device 1008, and the like which are connected to each other by a bus B.

The program for implementing the processing in the computer is provided by, for example, a recording medium 1001 such as a CD-ROM or a memory card. In a case where the recording medium 1001 storing the program is set in the drive device 1000, the program is installed from the recording medium 1001 to the auxiliary storage device 1002 via the drive device 1000. Here, the program is not necessarily installed from the recording medium 1001, and may be downloaded from another computer via a network. The auxiliary storage device 1002 stores the installed program, and also stores necessary files, data, and the like.

In a case where an instruction to start the program is input, the memory device 1003 reads the program from the auxiliary storage device 1002, and stores the program therein. The CPU 1004 implements functions related to the information processing device in accordance with the program stored in the memory device 1003. The interface device 1005 is used as an interface for connection to a network. The display device 1006 displays a graphical user interface (GUI) or the like according to the program. The input device 1007 includes a keyboard and a mouse, buttons, a touch panel, or the like, and is used to input various operation instructions. The output device 1008 outputs a computation result. Note that the computer may include a graphics processing unit (GPU) or a tensor processing unit (TPU) instead of the CPU 1004, and may include a GPU or a TPU in addition to the CPU 1004. In this case, for example, the processing may be shared and executed such that the GPU or the TPU executes processing requiring special computation and the CPU 1004 executes other processing.

### Effects of Present Embodiment

The information processing device according to the present embodiment calculates a deployment configuration of an application and a database for a plurality of server devices for processing data acquired from an IoT device, and controls each server device on the basis of a calculation result. This minimizes both the processing delay between the IoT device and the APL and the processing delay between the APL and the DB. Accordingly, it is possible to optimize arrangement of an application and a database.

### Summary of Embodiment

The present description describes at least an information processing device, a deployment configuration calculation method, and a program described in the following items.

### (Item 1)

An information processing device including:
a network information acquisition unit that acquires network information indicating a delay time of data transmission in a network including a data measurement device and a plurality of server devices; and
a deployment configuration calculation unit that calculates a deployment configuration of functions of an application and a database for processing data transmitted from the data measurement device to each of the plurality of server devices on the basis of the network information.

### (Item 2)

The information processing device according to Item 1,
in which the network information includes a first delay time in data transmission from a data measurement device to each of the plurality of server devices and a second delay time between server devices included in the plurality of server devices, and
the deployment configuration calculation unit calculates the deployment configuration by solving an integer programming problem of minimizing maximum values of the first delay time and the second delay time.

### (Item 3)

The information processing device according to Item 1 or 2, further including
a server control unit that performs control so that each of the plurality of server devices achieves the functions of an application and a database on the basis of the deployment configuration that has been calculated.

### (Item 4)

A deployment configuration calculation method performed by an information processing device, the deployment configuration calculation method including steps of:
acquiring network information indicating a delay time of data transmission in a network including a data measurement device and a plurality of server devices; and
calculating a deployment configuration of functions of an application and a database for processing data transmitted from the data measurement device to each of the plurality of server devices on the basis of the network information.

### (Item 5)

A program for causing a computer to function as each unit in the information processing device according to any one of Items 1 to 3.

Although the present embodiment has been described above, the present invention is not limited to such a specific embodiment, and various modifications and changes can be made within the scope of the gist of the present invention described in the claims.

### REFERENCE SIGNS LIST

1 Data processing system
10 Information processing device
11 Network information acquisition unit
12 Deployment configuration calculation unit
13 Server control unit
20 Server device
30 IoT device
40 Communication network
1000 Drive device
1001 Recording medium
1002 Auxiliary storage device
1003 Memory device
1004 CPU
1005 Interface device
1006 Display device
1007 Input device
1008 Output device

1. An information processing device comprising a processor configured to execute operations comprising:
acquiring network information indicating a delay time of data transmission in a network including a data measurement device and a plurality of server devices; and
calculating a deployment configuration of functions of an application and a database for processing data transmitted from the data measurement device to each of the plurality of server devices based on the network information.

2. The information processing device according to claim 1,
wherein the network information includes a first delay time in data transmission from a data measurement device to each of the plurality of server devices and a second delay time between server devices included in the plurality of server devices, and
the calculating further comprises calculating the deployment configuration the deployment configuration by solving an integer programming problem of minimizing maximum values of the first delay time and the second delay time.

3. The information processing device according to claim 1, further comprising
performing control so that each of the plurality of server devices achieves the functions of an application and a database based on the deployment configuration that has been calculated.

4. A computer implemented method for calculating deployment configuration, the method comprising steps of:
acquiring network information indicating a delay time of data transmission in a network including a data measurement device and a plurality of server devices; and
calculating a deployment configuration of functions of an application and a database for processing data transmitted from the data measurement device to each of the plurality of server devices based on the network information.

5. A computer-readable non-transitory recording medium storing a computer-executable program instructions that when executed by a processor cause a computer to execute operations comprising:
acquiring network information indicating a delay time of data transmission in a network including a data measurement device and a plurality of server devices; and
calculating a deployment configuration of functions of an application and a database for processing data transmitted from the data measurement device to each of the plurality of server devices based on the network information.

6. The information processing device according to claim 2, further comprising
performing control so that each of the plurality of server devices achieves the functions of an application and a database based on the deployment configuration that has been calculated.

7. The computer implemented method according to claim 4, wherein the network information includes a first delay time in data transmission from a data measurement device to each of the plurality of server devices and a second delay time between server devices included in the plurality of server devices, and
the calculating further comprises calculating the deployment configuration the deployment configuration by solving an integer programming problem of minimizing maximum values of the first delay time and the second delay time.

8. The computer implemented method according to claim 4, further comprising
performing control so that each of the plurality of server devices achieves the functions of an application and a database based on the deployment configuration that has been calculated.

9. The computer implemented method according to claim 7, further comprising
performing control so that each of the plurality of server devices achieves the functions of an application and a database based on the deployment configuration that has been calculated.

10. The computer-readable non-transitory recording medium according to claim 5, wherein the network information includes a first delay time in data transmission from a data measurement device to each of the plurality of server devices and a second delay time between server devices included in the plurality of server devices, and
the calculating further comprises calculating the deployment configuration the deployment configuration by solving an integer programming problem of minimizing maximum values of the first delay time and the second delay time.

11. The computer-readable non-transitory recording medium according to claim 5, further comprising
performing control so that each of the plurality of server devices achieves the functions of an application and a database based on the deployment configuration that has been calculated.

12. The computer-readable non-transitory recording medium according to claim 10, further comprising
performing control so that each of the plurality of server devices achieves the functions of an application and a database based on the deployment configuration that has been calculated.
